(19) United States
(12) Patent Application Publication
(10) Pub. No.: US 2007/0006307 A1
(43) Pub. Date: Jan. 4, 2007

(54) Systems, apparatuses and methods for a host software presence check from an isolated partition

(76) Inventors: Scott D. Hahn, Beaverton, OR (US); Travis Schluessler, Hillsboro, OR (US); Carey W. Smith, Hillsboro, OR (US); Ravi L. Sahita, Beaverton, OR (US); Howard C. Herbert, Phoenix, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/174,315

(22) Filed: Jun. 30, 2005

(51) Int. Cl. G06F 12/14

(52) U.S. Cl. 726/22

(57) ABSTRACT

Embodiments of the invention are generally directed to systems, apparatuses, and methods for a host software presence check from an isolated partition. In an embodiment, a presence verification component is located within an isolated partition. The isolated partition may be, for example, a service processor or a virtual partition implemented on a host platform. The presence verification component determines whether a host software agent is executing on the host platform. In one embodiment, the presence verification component initiates a remedial action, if the host software agent is not executing on the host platform. Other embodiments are described and claimed.

### RELATED APPLICATIONS

This application is related to U.S. patent application No. TBD [Attorney Docket No. P21998], titled, “Agent Presence Monitor Configured to Execute in a Secure Environment.”

### TECHNICAL FIELD

Embodiments of the invention generally relate to the field of computer security and, more particularly, to systems, apparatuses, and methods for a host software presence check from an isolated partition.

### BACKGROUND

Software vendors produce a large number of products that run within a host operating system (OS) context and provide management services to enterprise information technology departments (and other entities). These products include, for example, asset tracking, application monitoring, system performance monitoring, provisioning, intrusion detection, firewalls, virus protection, and the like. Typically, these software products are installed using an agent/console model in which the host software agent executes on the local client and communicates with a remote console that runs on a remote machine.

Unfortunately, in the conventional model, the host software agent is vulnerable to attack. In particular, a local user (or an entity with access to the local client) can compromise the host software agent by, for example, killing the process or stopping the service. The ability to compromise the host software agent has significant implications for the security of the client system. For example, local firewalls, virus protection software, intrusion agents, and other security systems can be killed or stopped because they are frequently implemented as host software agents.

In many cases, the remote console cannot easily determine whether these security agents have been compromised. The reason for this is that once a host software agent is compromised, the remote console cannot trust its interactions with the host software agent. In addition, the communication between the remote console and the host software agent may be compromised through the same mechanism that compromised the host software agent.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram showing selected aspects of a computing system, implemented according to an embodiment of the invention.

FIG. 2 is a flow diagram illustrating selected aspects of a sequence of operation, according to an embodiment of the invention.

FIG. 3 is a block diagram illustrating selected aspects of registering a host software agent with a presence verifier component, according to an embodiment of the invention.

FIG. 4 is a block diagram illustrating selected aspects of a timer according to an embodiment of the invention.

FIG. 5 is a block diagram illustrating the isolation of a node from a network according to an embodiment of the invention.

FIG. 6 is a block diagram illustrating selected aspects of a hardware-based embodiment of an isolated partition.

FIG. 7 is a block diagram of selected aspects of an embodiment in which an isolated partition is logically (rather than physically) implemented.

### DETAILED DESCRIPTION

Embodiments of the invention are generally directed to systems, apparatuses, and methods for a host software presence check from an isolated partition. As is further described below, in an embodiment, the presence of a host software agent is detected from an isolated partition. The isolated partition and the host software agent may be connected via a secure communication channel. In one embodiment, if the presence of a host software agent is not detected, then a remedial action can be initiated from the isolated partition.

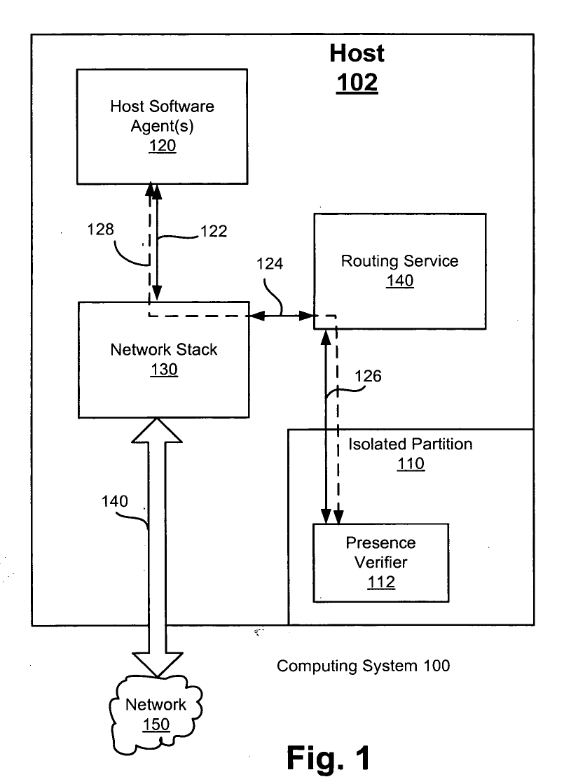

FIG. 1 is a block diagram showing selected aspects of a computing system 100, implemented according to an embodiment of the invention. Computing system 100 can be any of a wide number of computing systems including a desktop computer, a laptop computer, a server, a network infrastructure device (e.g., router, switch, etc.), a digital home entertainment system, a cellular phone, and the like.

Computing system 100 includes host 102 and isolated partition 110. Host 102 is the primary execution environment for computing system 100. The term “execution environment” broadly refers to a set of core resources (e.g., messaging, memory access, etc.) provided by a computing system to enable a software agent to execute on the computing system. Examples of an execution environment include (and are not limited to) a service partition, an embedded microcontroller, a virtual machine, and the like.

Host software agent 120 may be any software agent (e.g., program, module, etc.) that is executing on host 102. As used herein, the term “executing” not only refers to software that is currently running but it may also include software whose execution is interrupted (e.g., to share execution resources with other programs) or software that runs periodically (e.g., once per minute). That is, the term executing may include periodic execution and/or temporary interruption of execution (e.g., due to the scheduling of other tasks). In one embodiment, host software agent 120 provides a security or management service. Examples of such services include asset tracking, application monitoring, system performance monitoring, provisioning, intrusion detection, local firewall, virus protection, and the like.

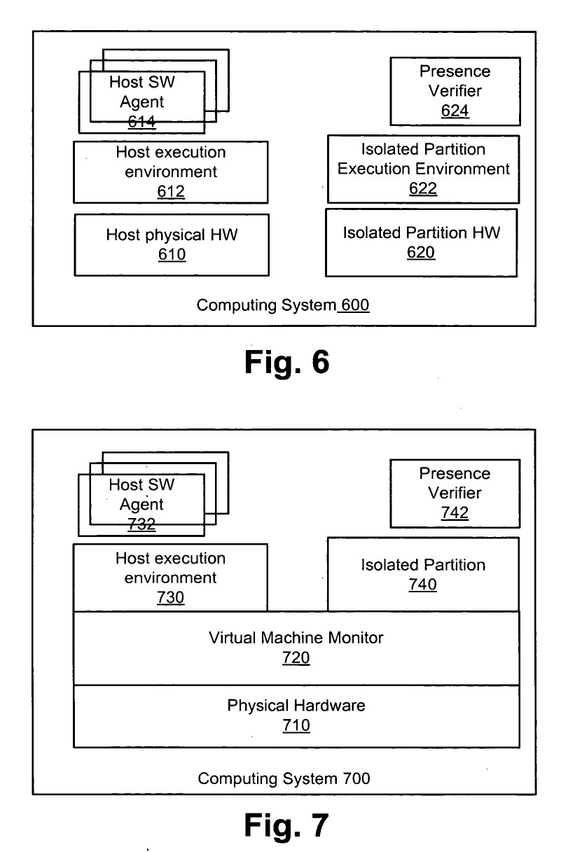

Isolated partition 110 provides an execution environment that cannot be reached from the host operating system (and/or the host processor). In an embodiment, the host operating system is unable to reach the memory and/or code store that supports isolated partition 110. Isolated partition 110 can be implemented in a number of different ways. For example, isolated partition 110 may be implemented as a service processor (e.g., a coprocessor or microcontroller) that is built into a chipset (e.g., hardware 620, shown in FIG. 6). Alternatively, isolated partition 110 may be implemented as an isolated partition in a partitioned environment. When implemented as hardware, isolated partition 110 may be isolated from the host hardware and when implemented as software, isolated partition 110 may be isolated from the host operating system. Implementations of isolated partition 110 are further discussed below with reference to FIGS. 6 and 7.

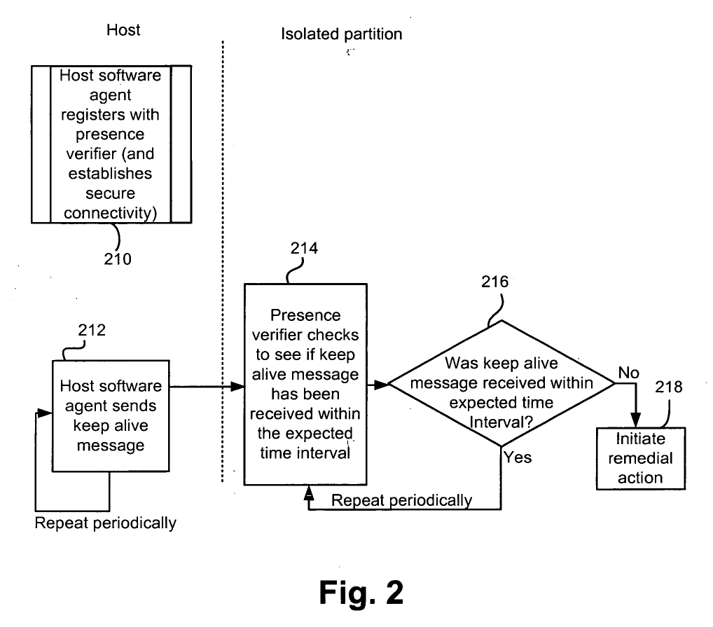

Isolated partition 110 includes presence verifier component 112. In an embodiment, presence verifier component 112 provides logic to determine whether host software agent 120 is executing on host 102. In addition, presence verifier component 112 may provide logic to initiate a remedial action if software agent 120 stops executing (or fails to start executing) on host 102. In an embodiment, presence verifier component 112 can be implemented in software, firmware, hardware, or any combination thereof. Presence verifier component (or, for ease of reference, presence verifier) 112 is further discussed below with reference to FIGS. 2-6.

As described above, host software agent 120 may be vulnerable to attack because it is executing within host 102. For example, an attacker may be able to interrupt or kill host software agent 120. Also, an attacker may be able to modify the scheduling tables of host 102 so that host software agent 120 does not get scheduled for execution. Alternatively, an attacker may be able to monopolize the allocation of execution resources on host 102 and thereby starve host software agent 120 of the resources that it needs to execute.

In one embodiment, isolated partition 110 substantially protects presence verifier 112 from attack. An attacker who compromises host 102 is able to compromise host software agent 120. That attacker, however, will not be able to reach presence verifier 112 because it is protected by isolated partition 110. In an embodiment, isolated partition 110 prevents an attacker from interrupting, stopping, and/or spoofing presence verifier 112. Therefore, presence verifier 112 can continue to perform its tasks, even when host 102 is comprised.

In an embodiment, host software agent 120 is coupled with presence verifier 112 (and/or isolated partition 110) via a secure communication channel 128. Secure communication channel 128 is a communication channel that protects the messages transmitted over the channel. The terms message, package, and frame are used interchangeably throughout this document. The security can be applied at almost any communication layer (e.g., link layer, network layer, etc.)

In one embodiment, network stack 130 provides the underlying security mechanisms for communication channel 128. Network stack 130 is a network communication protocol stack such as a transmission control protocol/Internet protocol (TCP/IP) stack. In such an embodiment, secure communication channel 128 may be based on the Transport Layer Security (TLS) protocol. The TLS protocol refers to any of the TLS protocols (or combinations thereof) including the protocol described in Request For Comments (RFC) 2246, “The TLS Protocol Version 1.0,” published in January 1999. In an alternative embodiment, the secure communication channel may be based on a different protocol (or a different combination of protocols). In an embodiment, the use of network stack 130 to provide security simplifies programming because it supports the use of standard networking applications programming interfaces (APIs). In addition, the use of network stack 130 allows for the use of standard security protocols such as TLS.

In an embodiment, routing service 140 routes messages between host software agent 120 and presence verifier 112 (and/or isolated partition 110). In the illustrated embodiment, routing service 140 is implemented on the host. In an alternative embodiment, routing service 140 is implemented in a different location on computing system 100. For example, routing service 140 may be implemented on a network interface card (NIC) or on a network controller (e.g., local area network (LAN) controller).

In an embodiment, network stack 130 provides access to network 150. Network 150 may be, for example, any combination of a wired or wireless network and may include any combination of a Local Area Network (LAN), a Wide Area Network (WAN), a Metropolitan Area Network (MAN), an intranet, and/or the Internet.

In an embodiment, secure communication channel 128 includes a number links. For example, in the illustrated embodiment, secure communication channel 128 includes links 122, 124, and 126. In an alternative embodiment, secure communication channel 128 may provide a direct connection channel between host software agent 120 and presence verifier 112 (and/or isolated partition 110).

FIG. 2 is a flow diagram illustrating selected aspects of a sequence of operation, according to an embodiment of the invention. In an embodiment, aspects of the sequence of operation may be performed by, for example, presence verifier 112 (shown in FIG. 1) operating within isolated partition 110. In an embodiment, presence verifier 112 (and/or isolated partition 110) may be implemented in software, hardware, firmware, and/or any combination thereof.

Referring to process block 210, a host software agent (e.g., host software agent 120, shown in FIG. 1) registers with a presence verifier. In an embodiment, registration can be implemented in a number of different ways. Examples of registration mechanisms that are suitable for use in embodiments of the invention include: static registration, discovery and/or dynamic registration. Static registration refers to statically configuring the registration of the host software agent with the presence verifier prior to host boot-up. Discovery refers to the presence verifier using a discovery mechanism to register the host software agent. Dynamic registration refers to using registration packets to dynamically register the host software agent.

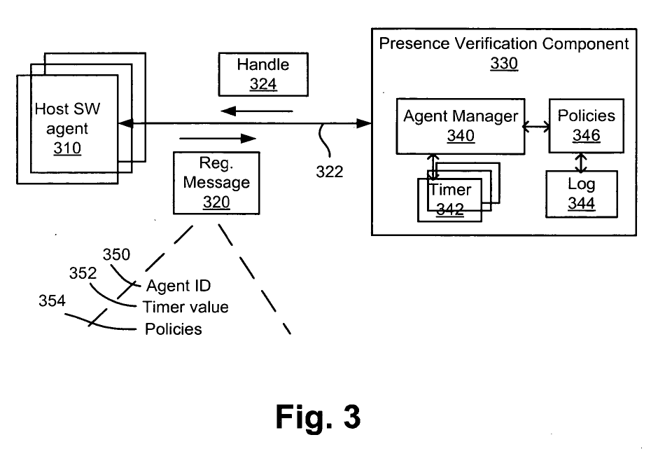

FIG. 3 is a block diagram illustrating selected aspects of registering a host software agent with a presence verifier, according to an embodiment of the invention. Host software agent 310 sends registration message 320 to presence verifier 330 over secure communication channel 322. In one embodiment, secure communication channel 322 is based, at least in part, on the TLS protocol.

Registration message 320 contains registration information to enable presence verifier 330 to monitor the presence of host software agent 310. In the illustrated embodiment, registration message 320 includes agent identifier (ID) 350, timer value 352, and policies 354. Agent ID 350 identifiers host software agent 310 to presence verifier 330. Timer value 352 provides a value to indicate, for example, when host software agent 310 registered with presence verifier 330. In one embodiment, policies 354 provide one or more remediation policies to indicate remedial actions presence verifier 330 is to initiate if host software agent 310 stops executing (and/or does not start to execute). Examples of remedial actions that may be indicated by policies 354 include: entering an event in an error log (either a local error log or a remote error log), generating an external event to alert an external computing system (e.g., a management console), and/or isolating (at least in part) the computing system from the network. Remedial actions are further discussed below. In one embodiment, presence verifier 330 returns handle 324 in response to receiving registration message 320. As is further discussed below, host software agent 310 may use handle 324 to communicate with presence verifier 330.

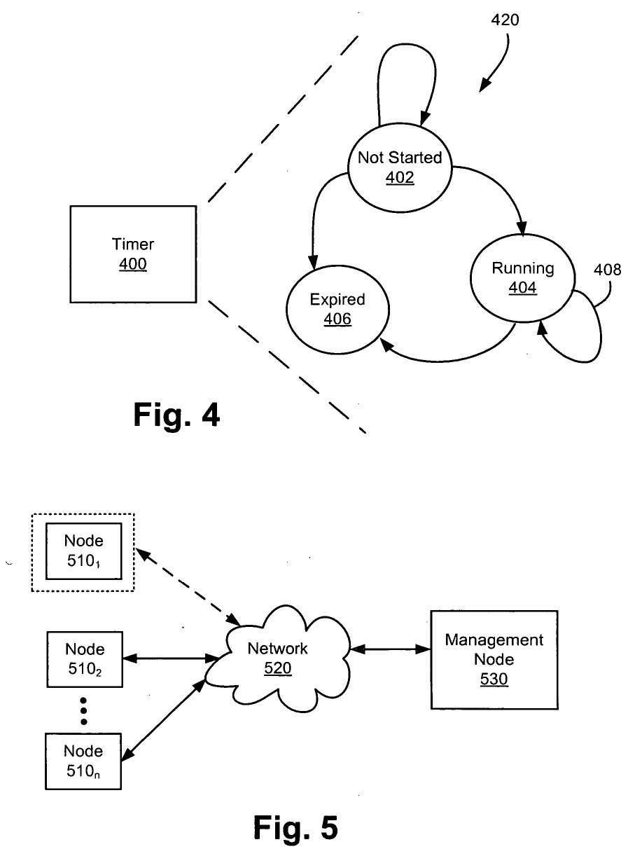

In an embodiment, presence verifier 330 includes agent manager 340, timer(s) 342, policies 346, and/or error log 344. Agent manager 340 is a logical agent that keeps track of the current state of one or more registered host software agents (using, for example, agent ID 350). Policies 346 are policies that indicate which (if any) remedial actions presence verify 330 is to take if host software agent 310 stops executing and/or fails to start executing. In one embodiment, presence verifier 330 logs errors that it detects in error log 344. In one embodiment, agent manager 340 maintains a timer 342 and an associated state machine (e.g., state machine 420, shown in FIG. 4) for each registered host agent. Timer 342 may be used to measure the amount of time that has elapsed since an event associated with host software agent 310 has occurred (e.g., how long it has been since a keep alive message was received). As is further discussed below, with reference to FIG. 4, the associated state machine may represent the state of host software agent 310.

FIG. 4 is a block diagram illustrating selected aspects of a timer according to an embodiment of the invention. In one embodiment, timer 400 maintains state machine 420. State machine 420 provides state information for a monitored host software agent (e.g., host software agent 310, shown in FIG. 3). The state information may indicate whether the host software agent is currently executing and/or whether the host software agent has started execution. In one embodiment, state changes occur based, at least in part, on whether keep alive messages are received from the host software agent. For example, state machine 420 may be initialized in not started state 402. If the host software agent registers with the presence verifier, then state machine 420 may transition to running state 404. If the host software agent does not register with the presence verifier, then state machine 420 may transition to expired state 406 after a predetermined length of time. Expired state 406 may indicate that the host software agent did not start.

In an embodiment, the host software agent periodically sends keep alive (or heartbeat) messages to the presence verifier. The presence verifier determines whether the host software agent is currently executing on the host based, at least in part, on the keep alive messages. For example, in one embodiment, the keep alive messages are used to periodically reset a countdown timer (e.g., associated with timer 400). Reference number 408 illustrates how resetting the countdown timer maintains state machine 420 in running state 404. If the countdown timer is not reset, then state machine 420 transitions to expired state 406 to indicate that the associated host software agent is no longer executing on the host.

It is to be appreciated that in alternative embodiments, timer 400 and the keep alive mechanism may be implemented differently. For example, in an alternative embodiment, the keep alive messages are used to increment a raw counter that is protected by a message authentication code. In another alternative embodiment, the state of a host software agent is represented, in part, by a monotonically increasing counter that is protected by an integrity check value (or a message authentication code). In yet another alternative embodiment, the presence verifier may periodically poll the registered host software agents to determine whether they are currently executing (or whether they started executing).

Referring again to FIG. 2, in an embodiment, the host software agent periodically sends keep alive (or heartbeat) messages to the presence verifier as shown by 212. The presence verifier determines whether the keep alive message(s) have been received within the expected time interval at 214. As described above, with reference to FIGS. 3-4, a number of mechanisms may be used to determine whether the keep alive messages have been received within the expected time interval including, for example, reset counters that are periodically reset by the keep alive messages. The process of determining whether the keep alive message(s) have been received may be periodically repeated as shown by 216.

Referring to process block 218, in an embodiment, the presence verifier initiates one or more remedial actions, if it determines that the host software agent is no longer executing and/or did not start executing. In an embodiment, almost any kind of remediation may be initiated by the presence verifier. The remedial actions may be based, at least in part, on policies that are set and/or updated by a management node (e.g., management node 530, shown in FIG. 5). In an embodiment, the policies may be set and/or updated prior to the host software agent starting and/or at any time after the agent starts.

In an embodiment, the presence verifier may isolate (or partly isolate) the host from a network, if it detects that the host software agent has failed to execute (e.g., stopped executing and/or did not start executing). Isolating the host from the network may help to prevent a virus (or other malware) from propagating from the host to other computing systems connected to the network. The presence verifier may initiate the isolation of the host by signaling one or more network interfaces (and/or controllers) to disconnect from the network. In one embodiment, the presence verifier isolates the host (at least in part) by installing a predefined circuit breaker filter on at least one network interface of the network. The term “circuit breaker filter” refers to an agent (e.g., software, hardware, firmware, and/or any combination thereof) that is capable of filtering network traffic on a network interface (e.g., wired and/or wireless).

FIG. 5 is a block diagram illustrating the isolation of a node from a network according to an embodiment of the invention. Nodes 510 are interconnected through network 520. The term node broadly refers to any computing system capable of connecting to network 520. Network 520 may be, for example, any combination of a wired or wireless network and may include any combination of a Local Area Network (LAN), a Wide Area Network (WAN), a Metropolitan Area Network (MAN), an intranet, and/or the Internet. Management node 530 includes management applications (e.g., security, provisioning, monitoring, and the like) to manage, at least in part, nodes 510.

In an embodiment, node 510₁ includes a presence verifier implemented within an isolated partition. The presence verifier monitors whether one or more host software agents are executing on node 510₁ from the isolated partition. In one embodiment, the presence verifier isolates (or partly isolates) node 510 from network 520, if it determines that at least one monitored host software agent has failed to execute. The term “monitored host software agent” refers to a host software agent whose presence is verified by a presence verifier (e.g., presence verifier 112, shown in FIG. 1) that is protected by an isolated partition (e.g., isolated partition 110, shown in FIG. 1). The isolation of node 510₁ is illustrated by the dotted line surrounding node 510₁. In one embodiment, after node 510₁ is partly isolated from network 520, the presence verifier may communicate with management node 530. For example, the presence verifier may alert management node 530 that the host software agent has failed to execute. Management node 530 may provide remediation instructions to the presence verifier responsive, at least in part, to receiving an event that indicates the host software agent has failed to execute. The communication may occur over an out-of-band communication channel between the presence verifier and management node 530.

It is to be appreciated that the presence verifier may initiate many other kinds of remedial actions instead of (or in addition to) isolating the host from the network. For example, the presence verifier may log an event in a local (and/or a remote) error log (e.g., log 344, shown in FIG. 3). The presence verifier may alert a management console and/or a user that the host software agent has failed to execute. In an embodiment, the presence verifier initiates a restart (or reload) of the host software agent that has failed to execute.

FIG. 6 is a block diagram illustrating selected aspects of a hardware-based embodiment of an isolated partition. Computing system 600 includes host physical hardware 610 and isolated partition hardware 620. Host physical hardware 610 includes, for example, one or more processors and associated memory to support host execution environment 612. Host execution environment 612 provides an execution environment for host software agent(s) 614.

Isolated partition hardware 620 provides hardware that cannot be reached by host physical hardware 610. Isolated partition hardware may be, for example, a coprocessor, service processor, embedded microprocessor, and the like. Isolated partition execution environment 622 is an execution environment (e.g., kernel, operating system, virtual machine, and the like) that cannot be reached by host execution environment 612. In an embodiment, presence verifier 624 executes on isolated partition hardware 620. Presence verifier 624 is protected from an attacker who compromises host execution environment 612 (at least in part) because host physical hardware 610 cannot reach isolated partition hardware 620.

FIG. 7 is a block diagram of selected aspects of an embodiment in which an isolated partition is logically (rather than physically) implemented. Computing system 700 includes hardware 710. Hardware 710 represents the physical resources of computing system 700 including, for example, one or more processors, memory devices, input/output controllers, and the like. Virtual machine monitor 720 is a logical layer that enables computing system 700 to be logically partitioned into two or more virtual partitions. In the illustrated embodiment, host execution environment 730 is implemented in one virtual partition and isolated partition 740 is implemented within another virtual partition. In an embodiment, host execution environment 730 cannot access the memory or code store that support isolated partition 740. Presence verifier 742 is protected from an attacker who compromises host execution environment 730 (at least in part) because it is executing in isolated partition 740.

Elements of embodiments of the present invention may also be provided as a machine-readable medium for storing the machine-executable instructions. The machine-readable medium may include, but is not limited to, flash memory, optical disks, compact disks-read only memory (CD-ROM), digital versatile/video disks (DVD) ROM, random access memory (RAM), erasable programmable read-only memory (EPROM), electrically erasable programmable read-only memory (EEPROM), magnetic or optical cards, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of embodiments of the invention, various features are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed subject matter requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

What is claimed is:

1. An apparatus comprising:
an isolated partition to be implemented on a computing system, the isolated partition having a presence verifier component, wherein the presence verifier component is capable of determining whether a host software agent is executing on the computing system; and
an input to couple with a secure communications channel, wherein the secure communications channel is to couple the isolated partition with the host platform.

2. The apparatus of claim 1, wherein the secure communication channel is based, at least in part, on the Transport Layer Security (TLS) protocol.

3. The apparatus of claim 1, wherein the isolated partition is one of:
a service processor;
a virtual partition; and
an embedded microcontroller.

4. The apparatus of claim 1, wherein the presence verifier component comprises:
an indication of registration for the host software agent.

5. The apparatus of claim 4, wherein the indication of registration comprises at least one of:
a host software agent identifier; and
a timer value to indicate a start time of the host software agent.

6. The apparatus of claim 4, wherein the presence verifier component further comprises:
a remediation initiation policy.

7. The apparatus of claim 6, wherein the remediation initiation policy comprises at least one of:
a policy to enter an event in an error log, wherein the event indicates that the host software agent is not executing on the computing system;
a policy to generate an external event to alert an external computing system that the host software agent is not executing on the computing system; and
a policy to isolate, at least in part, the computing system from a network.

8. A method comprising:
determining, from an isolated partition, whether a monitored software agent is executing on a computing system, wherein the isolated partition is located on the computing system; and
initiating a remedial action, if the monitored software agent is not executing on the computing system.

9. The method of claim 8, wherein determining, from the isolated partition, whether the monitored software agent is executing on the computing system comprises at least one of:
receiving, over a secure communication channel, a message from the monitored software agent, the message indicating that the monitored software agent is executing on the computing system.

10. The method of claim 9, wherein receiving the message, over the secure communication channel, from the monitored software agent comprises:
receiving a heartbeat message from the monitored software agent over a secure communication channel.

11. The method of claim 10, further comprising:
resetting a timer associated with the monitored software agent responsive, at least in part, to receiving the heartbeat message.

12. The method of claim 9, wherein the secure communication channel is based, at least in part, on the Transport Layer Security (TLS) protocol.

13. The method of claim 8, wherein initiating the remedial action comprises at least one of:
entering an event in an error log, wherein the event indicates that that the monitored software agent is not executing on the computing system;
generating an external event to alert an external computing system that the monitored software agent is not executing on the computing system; and
isolating, at least in part, the computing system from a network.

14. The method of claim 13, wherein isolating, at least in part, the computing system from the network comprises:
installing a predefined circuit breaker filter on at least one network interface of the network.

15. The method of claim 8, wherein the isolated partition is at least one of:
a service processor;
a virtual partition; and
an embedded microcontroller.

16. The method of claim 8, further comprising:
registering the monitored software agent with a presence verifier component, wherein the presence verifier component is executing within the isolated partition.

17. A system comprising:
a host software agent to execute within a host execution environment; and
an isolated partition coupled with the host execution environment, the isolated partition having a presence verifier component, wherein the presence verifier component is capable of detecting whether the host software agent is executing within the host execution environment.

18. The system of claim 17, further comprising:
a secure communication channel; and wherein
the isolated partition is coupled with the host software agent via the secure communication channel.

19. The system of claim 18, wherein the secure communication channel is based, at least in part, on the Transport Layer Security (TLS) protocol.

20. The system of claim 18, wherein the presence verifier component is capable of receiving a message from the host software component over the secure communication channel.

21. The system of claim 20, wherein the message is at least one of:
a registration message; and
a heartbeat message.

22. The system of claim 21, wherein the presence verification component is capable of initiating a remedial action responsive, at least in part, to determining that the host software agent is not executing within the host execution environment.

23. The system of claim 22, wherein the presence verifier component comprises:
a timer to indicate whether a message has not been received from the host software agent; and
a log file to log an event associated with the host software agent.
